(19) United States
(12) Patent Application Publication
(10) Pub. No.: US 2007/0085330 A1
(43) Pub. Date: Apr. 19, 2007

(54) Paper fastener having coupling device

(76) Inventor: Chih Chiang Huang, Changhua Hsien (TW)

Correspondence Address: CHARLES E. BAXLEY, ESQ., 90 JOHN STREET, THIRD FLOOR, NEW YORK, NY, 10038, US

(21) Appl. No.: 11/182,417

(22) Filed: Jul. 15, 2005

(51) Int. Cl. B42D 7/00

(52) U.S. Cl. 281/45

(57) ABSTRACT

A paper fastener includes a head, and two opposed and narrow ends or prongs extended from the head, for engaging through paper sheets or other objects, and the head includes a coupling device having an orifice formed therein for attaching to various objects. The coupling device may be a ring, an ear, a hook, a loop or the like. A wire may further be engaged through the orifice of the coupling device, for hanging or coupling to various objects.

### BACKGROUND OF THE INVENTION

1. Field of the Invention

The present invention relates to a paper fastener, and more particularly to a paper fastener having an extended ear or hook or coupling device, for hooking or hanging the paper fastener to the other objects, and/or for coupling two or more paper fasteners together.

2. Description of the Prior Art

Typical paper fasteners comprise an enlarged head, and two opposed and narrow ends or prongs extended from the enlarged head, for engaging through paper sheets or the like, and for fastening or securing the paper sheets together.

For example, U.S. Pat. No. 1,146,231 to Arant, and U.S. Pat. No. 1,513,049 to Krehbiel, and U.S. Pat. No. 1,646,053 to Clark, and U.S. Pat. No. 2,480,323 to Derman disclose four of the typical paper fasteners each also comprising two opposed and narrow ends or prongs extended from an enlarged head, for engaging through paper sheets or the like, and for fastening or securing the paper sheets together.

However, after the two opposed and narrow ends or prongs are attached or engaged through paper sheets or the like, only the rounded enlarged head of the typical paper fastener is exposed, such that the typical paper fastener may not be hooked or attached or coupled to the other objects.

The present invention has arisen to mitigate and/or obviate the afore-described disadvantages of the conventional paper fasteners.

### SUMMARY OF THE INVENTION

The primary objective of the present invention is to provide a paper fastener including an outwardly extended ear or hook or coupling device, for hooking or hanging the paper fastener to the other objects, and/or for coupling two or more paper fasteners together.

In accordance with one aspect of the invention, there is provided a paper fastener comprising a head, and two prongs extended from the head, for engaging through paper sheets or objects, and the head includes a coupling device extended therefrom, and having an orifice formed therein for attaching to various objects.

The coupling device may be a ring, an ear, a hook, a loop or the like. A cable or rope or wire may further be provided and engaged through the orifice of the coupling device, for coupling to various objects with the wire.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a paper fastener in accordance with the present invention;

FIG. 2 is a perspective view illustrating the operation of the paper fastener;

FIG. 3 is a perspective view similar to FIG. 2, illustrating the further operation of the paper fastener;

FIG. 4 is another perspective view similar to FIGS. 2 and 3, illustrating the other application of the paper fastener; and

FIG. 5 is another perspective view similar to FIGS. 2-4, illustrating the further application of the paper fastener.

### DETAILED DESCRIPTION OF THE PREFERRED EMBODIMENT

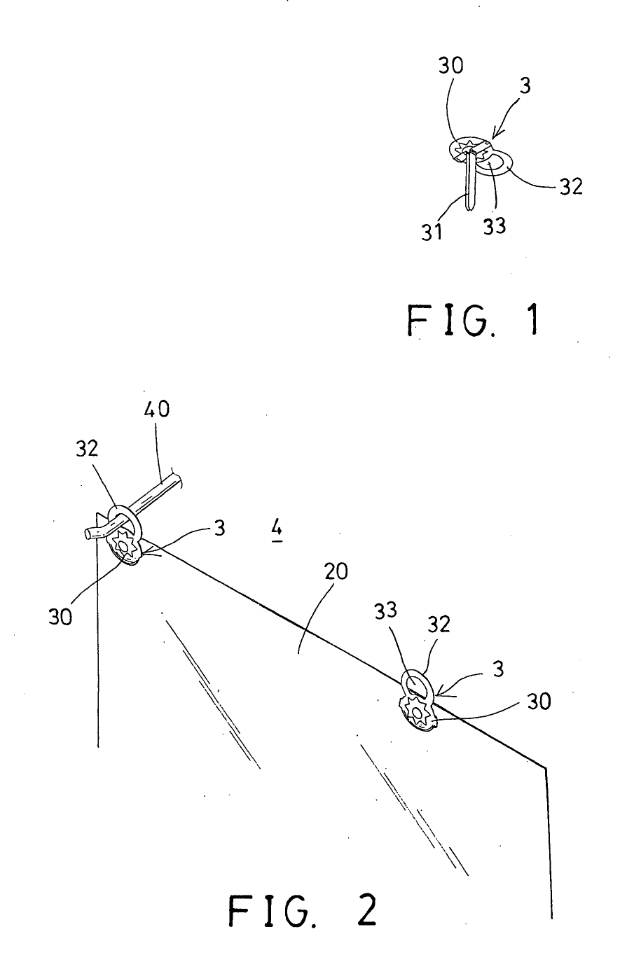

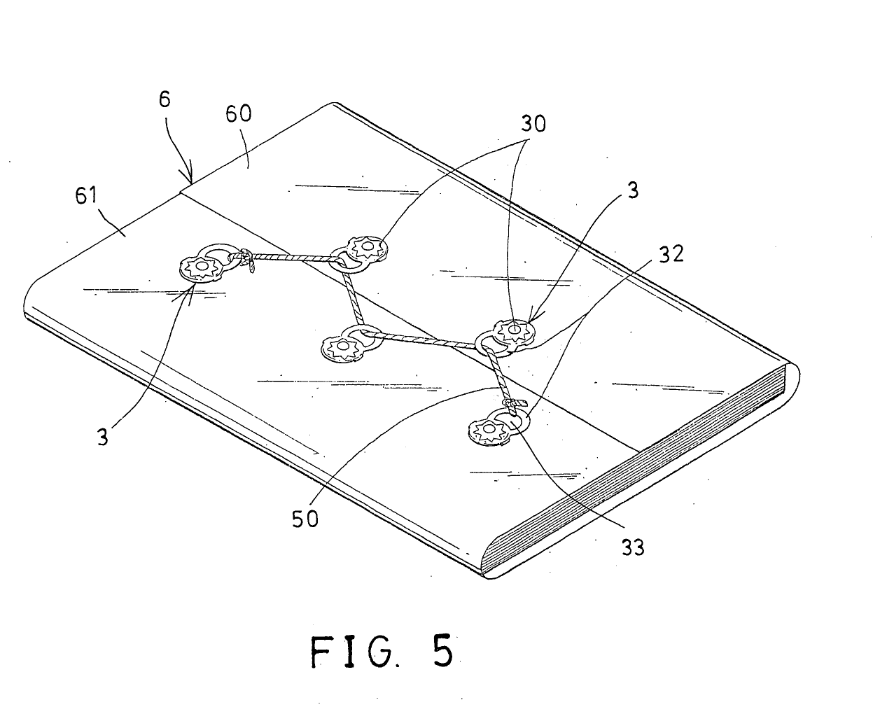

Referring to the drawings, and initially to FIGS. 1 and 2, a paper fastener 3 in accordance with the present invention also comprises an enlarged head 30, and two opposed and narrow ends or prongs 31 extended from the enlarged head 30, for engaging through paper sheets 20 (FIGS. 2-4), the files or pockets or suitcases 6 (FIG. 5), or the like, and for fastening or securing the paper sheets 20 together.

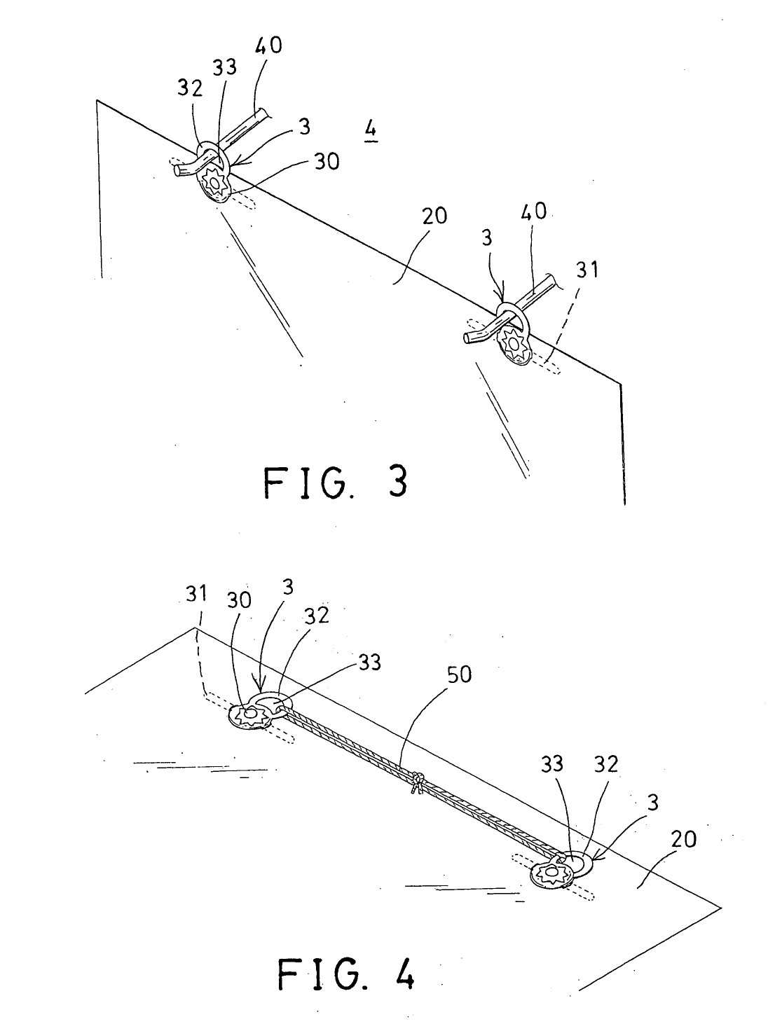

The paper fastener 3 further includes an ear or hook or loop or ring or coupling device 32 extended therefrom, such as extended from the enlarged head 30 thereof, and having an orifice 33 formed therein, for hooking or hanging the paper fastener 3 to the other objects 4 (FIGS. 2, 3), such as to the pegs 40 of the walls or cabinets 4, or the like, and thus for easily and readily attaching or hooking or hanging the paper fastener 3 to the other objects 4.

As shown in FIG. 4, a cable or rope or wire 50 may further be provided and coupled to or between the coupling devices 32 of two paper fasteners 3, for allowing the paper fasteners 3 and the paper sheets 20 to be attached or hooked or hung to various objects with the wire 50.

As shown in FIG. 5, two or more paper fasteners 3 may be attached to the cover 60 and the base 61 of an object 6, such as the file or pocket or suitcase 6, or the like, and the cable or rope or wire 50 may further be provided and coupled to or through the coupling devices 32 of the paper fasteners 3, for allowing the paper fasteners 3 to hook or to couple the cover 60 and the base 61 of the object 6 with the wire 50.

It is to be noted that, without the extended coupling device 32 from the paper fastener 3, the paper fastener 3 and the paper sheets 20 may not be fastened or secured or attached to the other objects. On the contrary, when the paper fastener 3 has one or more coupling devices 32 extended therefrom, the paper fastener 3 and thus the paper sheets 20 may be easily and readily fastened or secured or attached to the other objects directly with the coupling device 32, or indirectly with the wires 50.

Accordingly, the paper fastener in accordance with the present invention includes an outwardly extended ear or hook member or coupling device, for hooking or hanging the paper fastener to the other objects, and/or for coupling two or more paper fasteners together.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A paper fastener comprising:
a head, and
two prongs extended from said head, for engaging through paper sheets or objects, and
said head including a coupling device extended therefrom, and having an orifice formed therein for attaching to various objects.

2. The paper fastener as claimed in claim 1, wherein said coupling device is a ring.

3. The paper fastener as claimed in claim 1 further comprising a wire engaged through said orifice of said coupling device, for coupling to various objects.
